(19) United States
(12) Patent Application Publication
(10) Pub. No.: US 2014/0076032 A1
(43) Pub. Date: Mar. 20, 2014

(54) WATERPROOF TESTING SYSTEM AND METHOD THEREOF

(71) Applicant: ASKEY COMPUTER CORP., New Taipei City (TW)

(72) Inventor: Shau-Chiuan Wu, New Taipei City (TW)

(73) Assignee: ASKEY COMPUTER CORP., NEW TAIPEI CITY (TW)

(21) Appl. No.: 13/721,033

(22) Filed: Dec. 20, 2012

(30) Foreign Application Priority Data
Sep. 14, 2012 (TW) 101133843

(51) Int. Cl. G01L 13/00

(52) U.S. Cl. CPC G01L 13/00
USPC 73/40

(57) ABSTRACT

A waterproof testing system and a method thereof are provided. The method includes a master device controls a gas tester to adjust gas pressure for a sample; when the master device determines an effect pressure value is equal to a goal pressure value, the master device controls the gas tester to adjust gas pressure for the sample to the goal pressure value continuing in a first length of time; the master device determines whether the effect pressure value still maintains within a first pressure range; if yes, the master device controls the gas tester to stop adjusting the gas pressure for the sample; the master device determines whether the effect pressure value maintains within a second pressure range; if yes, the master device determines a time the effect pressure value maintains within the second pressure range exceeded a second length of time; and if yes, the waterproof test is successful.

### CROSS-REFERENCE TO RELATED APPLICATION

This application claims the priority benefit of Taiwan application serial no. 101133843, filed on Sep. 14, 2012. The entirety of the above-mentioned patent application is hereby incorporated by reference herein and made a part of this specification.

### BACKGROUND OF THE INVENTION

1. Field of the Invention

The invention relates to a waterproof testing system and a method thereof, and more particularly to a waterproof testing system and a method thereof which determine whether the waterproof function of a sample is well by adjusting gas pressure for the sample.

2. Description of Related Art

With currently available techniques, a conventional gas positive/negative pressure tester has to rely on human's visual observation to obtain the waterproof test data of a sample; whether the waterproof function of the sample is good or not is determined at human's discretion. In that case, the deviation results from human negligence affects the test data and may lead to a wrong judgment over the waterproof function of the sample. Besides, human inspection may cause human resource costs as well as testing time to increase and the efficiency of an overall testing process may also decrease.

### SUMMARY OF THE INVENTION

The invention provides a waterproof testing system, including a sample, a gas tester, and a master device. The master device is connected to the gas tester to control the gas tester to adjust gas pressure for the sample and to control the gas tester to read an effect pressure value that is being affected on the sample. Then the master device determines whether the effect pressure value is equal to a goal pressure value. If the result is positive, then the gas tester is controlled to adjust the gas pressure for the sample to the goal pressure value to last for a first length of time. Then the gas tester reads the effect pressure value affected on the sample and the master device determines whether the effect pressure value still maintains within a first pressure range relative to the goal pressure value. If the result is positive, then the gas tester is controlled to stop adjusting the gas pressure for the sample and to read the effect pressure value affected on the sample. Then the master device determines whether the effect pressure value still maintains within a second pressure range relative to the goal pressure value. If the result is positive, then the master device continues to determine whether a time in which the effect pressure value maintains within the second pressure range relative to the goal pressure value has exceeded a second length of time. If the result is positive, then it is determined that the waterproof test is successful.

In one embodiment of the invention, the waterproof testing system further includes that when the master device controls the gas tester to adjust the gas pressure for the sample and determines that the effect pressure value has not been equal to the goal pressure value, then the master device continues to determine whether an operation of adjusting the gas pressure has exceeded a predetermined time limit. If the result is positive, then it is determined that the waterproof test fails.

In one embodiment of the invention, the waterproof testing system further includes that when the master device controls the gas tester to adjust the gas pressure for the sample and determines that the effect pressure value has not been equal to the goal pressure value, then the master device continues to determine whether the operation of adjusting the gas pressure has exceeded the predetermined time limit. If the master device determines that the operation of adjusting the gas pressure has not exceeded the predetermined time limit, then the master device continues to control the gas tester to adjust the gas pressure for the sample.

In one embodiment of the invention, the waterproof testing system further includes that after the master device controls the gas tester to adjust the gas pressure for the sample to the goal pressure value to last for the first length of time, the master device determines whether the effect pressure value still maintains within the first pressure range relative to the goal pressure value. If the result is negative, then it is determined that the waterproof test fails.

In one embodiment of the invention, the waterproof testing system further includes that after the master device controls the gas tester to stop adjusting the gas pressure for the sample, the master device determines whether the effect pressure value affected on the sample still maintains within the second pressure range relative to the goal pressure value. If the result is negative, then it is determined that the waterproof test fails.

In one embodiment of the invention, the waterproof testing system further includes that when the master device further determines that the time in which the effect pressure value maintains within the second pressure range relative to the goal pressure value has not exceeded the second length of time, the master device then continues to control the gas tester to read the effect pressure value affected on the sample to determine whether the effect pressure value maintains within the second pressure range relative to the goal pressure value.

In one embodiment of the invention, the aforementioned master device is connected to the gas tester through a RS-232 interface. The gas tester is connected to the sample through a gas pipe.

The invention provides a waterproof testing method, using a gas tester to adjust gas pressure for a sample to test the waterproofing capability of the sample. The waterproof testing method includes controlling the gas tester to adjust the gas pressure for the sample and controlling the gas tester to synchronously read an effect pressure value being affected on the sample; determining whether the effect pressure value is equal to a goal pressure value; if the result is positive, then controlling the gas tester to adjust the gas pressure for the sample to the goal pressure value to last for a first length of time, then reading the effect pressure value affected on the sample; determining whether the effect pressure value still maintains within a first pressure range relative to the goal pressure value; if the result is positive, then controlling the gas tester to stop adjusting the gas pressure for the sample and reading the effect pressure value affected on the sample; the master device determining whether the effect pressure value maintains within a second pressure range relative to the goal pressure value; if the result is positive, then the master device continues to determine whether a time in which the effect pressure value maintains within the second pressure range relative to the goal pressure value has exceeded a second length of time; if the time has exceeded the second length of time, then it is determined that the waterproof test is successful.

Based on the above, the invention provides a waterproof testing system and a method thereof The master device uses the gas tester to adjust the gas pressure for the sample and obtains test data automatically for determining whether the waterproof test for the sample is successful. Human labor is no longer required for interpreting the test data for the waterproof capability of the sample, so a more objective and accurate judgment over the waterproof capability of the sample may be made. Also, human labor is no longer required for carrying out testing steps, so the overall waterproof testing process may run faster and more efficiently, thereby decreasing human resource costs to a large extent.

In order to make the aforementioned features and advantages of the invention more comprehensible, embodiments accompanying figures are described in detail below.

### BRIEF DESCRIPTION OF THE DRAWINGS

FIG. 1 is a functional block diagram of a waterproof testing system according to embodiments of the invention.

FIG. 2 is a flow chart of a waterproof testing method according to embodiments of the invention.

### DESCRIPTION OF EMBODIMENTS

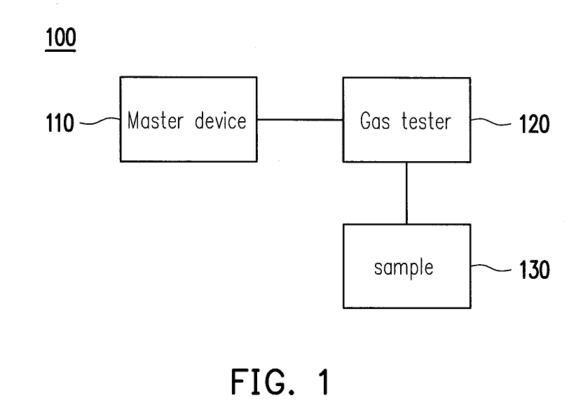

FIG. 1 is a functional block diagram of a waterproof testing system according to embodiments of the invention. The waterproof testing system 100 includes a master device 110, a gas tester 120, and a sample 130. The master device 110 is connected to the gas tester 120 through an asynchronous data transfer standard interface (RS-232). The gas tester 120 is connected to the sample 130 through a gas pipe. The master device 110 may be electronic facilities such as a large computer, a desktop computer, a notebook computer, and a tablet PC. The master device 110 has a functional mold block implemented by hardware and/or software, wherein the hardware may include a hardware facility having calculation function such as a central processing unit, a chipset, a micro-processor, or a combination of all the above, and the software may be an operating system, a driving program, etc. Accordingly, the master device 110 is able to control the gas tester 120 to adjust gas pressure for the sample 130 and to know whether the water function of the sample 130 is well based on test result.

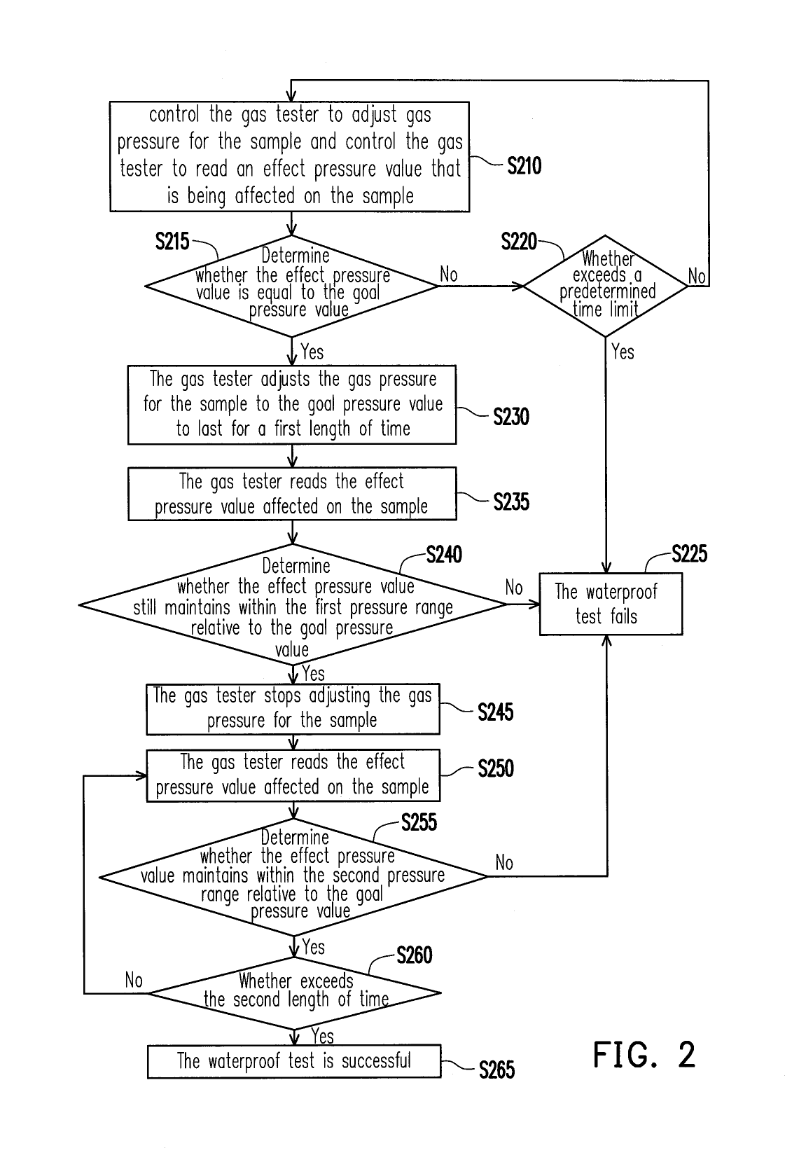

FIG. 2 is a flow chart of a waterproof testing method according to embodiments of the invention. Please refer to both FIGS. 1 and 2. The waterproof testing method may be separated into three stages: pressure applying, pressure stabilizing, and pressure holding. The detail is described below. The first stage is the pressure applying stage. The master device 110 controls the gas tester 120 to adjust the gas pressure for the sample 130 and controls the gas tester 120 to read an effect pressure value being affected on the sample 130 (step S210), wherein a method of adjusting the gas pressure is that the master device 110 controls the gas tester 120 to add or reduce pressure for the sample 130. Next, the master device 110 determines whether the effect pressure value is equal to a goal pressure value (step S215). If it is determined in step S215 that the effect pressure value has not been equal to the goal pressure value, then the master device 110 continues to determine whether a time in which the gas tester 120 operates to add or reduce pressure exceeds a predetermined time limit (step S220). If the result is positive in the step S220, then it is determined that the waterproof test for the sample 130 fails (step S225). However, if the result is negative in the step S220, i.e. the operation time has not exceeded the predetermined time limit, then the step S210 is resumed. The master device 110 continues to control the gas tester 120 to add or reduce pressure for the sample 130. The aforementioned steps are for the pressure applying stage of the waterproof testing method of the invention, wherein the aforementioned goal pressure value and predetermined time limit may be further designed and modified by users depending on the demand for the accuracy of the waterproof test.

If the result in the step S215 is positive, then the test enters the pressure stabilizing stage of the waterproof testing method. The master device 110 controls the gas tester 120 to adjust the gas pressure for the sample 130 to the goal pressure value to last for a first length of time (step S230), wherein the first length of time may be further designed depending on the demand for the accuracy of the waterproof test. Thereafter, the gas tester 120 reads the effect pressure value affected on the sample 130 (step S235). Then, the master device 110 determines whether the effect pressure value still maintains within a first pressure range relative to the goal pressure value (step S240). In other words, the step S240 is to determine whether the effect pressure value affected on the sample 130 is within an acceptable deviation range at an upper and lower limit relative to the goal pressure value. The first pressure range may be further designed by users depending on the demand of the test. If the result in the step S240 is negative, then it is determined that the waterproof test fails (step S225).

If the result in the step S240 is positive, then the test enters the pressure holding stage of the waterproof testing method. The master device 110 controls the gas tester 120 to stop adjusting the gas pressure for the sample 130 (step S245). Also, the master device 110 controls the gas tester 120 to read the effect pressure value affected on the sample 130 (step S250). The master device 110 then determines whether the effect pressure value maintains within a second pressure range relative to the goal pressure value (step S255). Similarly, the step S255 is to determine whether the effect pressure value affected on the sample 130 is within the acceptable deviation range at the upper and lower limit relative to the goal pressure value. The second pressure range may also be further designed by the users depending on the demand of the test. If the result in the step S255 is negative, then it is determined that the waterproof test fails (step S225).

If the result in the step S255 is positive, then the master device 110 continues to determine whether a time in which the effect pressure value maintains within the second pressure range relative to the goal pressure value has exceeded a second length of time (step S260), wherein the second length of time may also be further designed depending on the demand for the accuracy of the waterproof test. If the result in the step S260 is negative, then the step S250 is resumed. The master device 110 continues to control the gas tester 120 to read the effect pressure value affected on the sample 130 to determine whether the effect pressure value maintains within the second pressure range relative to the goal pressure value. When the result in the step S260 is positive, it means that the effect pressure value is still able to maintain within the second pressure range after the second length of time, and then it is determined that the waterproof test is successful (step S265).

Base on the above, the invention provides a waterproof testing system and a method thereof. The master device uses the gas tester to adjust the gas pressure for the sample and to determine whether the waterproof test for the sample is successful through the pressure applying, stabilizing, and holding stages. The invention uses the master device to obtain the test data automatically. Human labor is not required for interpreting the test data for the waterproof capability of the sample. Therefore, the judgment over the waterproof capability of the sample may be more objective and accurate so that human errors may be avoided. Meanwhile, human labor is no longer required for carrying out testing steps, so the overall waterproof testing process may run faster and more efficiently, thereby decreasing human resource costs to a large extent.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A waterproof testing system, comprising:
a sample;
a gas tester for being connected to the sample; and
a master device for being connected to the gas tester to control the gas tester to adjust gas pressure for the sample, and to control the gas tester to read an effect pressure value being affected on the sample, the master device determining whether the effect pressure value is equal to a goal pressure value, if the result is positive, then the gas tester being controlled to adjust the gas pressure for the sample to the goal pressure value to last for a first length of time, the gas tester reading the effect pressure value affected on the sample, the master device determining whether the effect pressure value still maintains within a first pressure range relative to the goal pressure value, if the result is positive, the gas tester being controlled to stop adjusting the gas pressure for the sample and to read the effect pressure value affected on the sample, the master device determining whether the effect pressure value maintains within a second pressure value relative to the goal pressure value, if the result is positive, the mater device continuing to determine whether a time in which the effect pressure value maintains within the second pressure range relative to the goal pressure value has exceeded a second length of time, and if the result is positive, determining that the waterproof test is successful.

2. The waterproof testing system according to claim 1, further comprising that after the master device controls the gas tester to adjust the gas pressure for the sample, the master device determining that the effect pressure value has not been equal to the goal pressure value, then continuing to determine whether a time in which an operation of adjusting the gas pressure exceeds a predetermined time limit, and if the result is positive, determining that the waterproof test fails.

3. The waterproof testing system according to claim 1, further comprising that after the master device controls the gas tester to adjust the gas pressure for the sample and determines that the effect pressure value has not been equal to the goal pressure value, the master device continuing to determine whether the time in which the operation of adjusting the gas pressure exceeds a predetermined time limit, and if it is determined that the time has not exceeded the predetermined time limit, continuing to control the gas tester to adjust the gas pressure for the sample.

4. The waterproof testing system according to claim 1, further comprising that after the master device controls the gas tester to adjust the gas pressure for the sample to the goal pressure value to last for the first length of time, the master device determining whether the effect pressure value still maintains within the first pressure range relative to the goal pressure value, and if the result is negative, determining that the waterproof test fails.

5. The waterproof testing system according to claim 1, further comprising that after the master device controls the gas tester to stop adjusting the gas pressure for the sample, the master device determining whether the effect pressure value affected on the sample maintains within the second pressure range relative to the goal pressure value, and if the result is negative, determining that the waterproof test fails.

6. The waterproof testing system according to claim 1, further comprising that when the master device continues to determine that the time in which the effect pressure value maintains within the second pressure range relative to the goal pressure value has not exceeded the second length of time, the gas tester being controlled to read the effect pressure value affected on the sample, determining whether the effect pressure value maintains within the second pressure range relative to the goal pressure value.

7. The waterproof testing system according to claim 1, wherein the master device is connected to the gas tester through a RS-232 interface and the gas tester is connected to the sample through a gas pipe.

8. The waterproof testing system according to claim 1, wherein a method of adjusting the gas pressure is that the master device controls the gas tester to add or reduce pressure for the sample.

9. A waterproof testing method using a gas tester to adjust gas pressure for a sample to test a waterproof capability of the sample, comprising:
controlling the gas tester to adjust the gas pressure for the sample, and controlling the gas tester to read an effect pressure value affected on the sample;
determining whether the effect pressure value is equal to a goal pressure value;
if the result is positive, then controlling the gas tester to adjust the gas pressure for the sample to the goal pressure value to last for a first length of time, and reading the effect pressure value affected on the sample;
determining whether the effect pressure value still maintains within a first pressure range relative to the goal pressure value;
if the result is positive, then controlling the gas tester to stop adjusting the gas pressure for the sample and reading the effect pressure value affected on the sample;
determining whether the effect pressure value maintains within a second pressure range relative to the goal pressure value;
if the result is positive, continuing to determine whether a time in which the effect pressure value maintains within the second pressure range relative to the goal pressure value has exceeded a second length of time; and
if the time has exceeded the second length of time, determining that the waterproof test is successful.

10. The waterproof testing method according to claim 9, further comprising:
after controlling the gas tester to adjust the gas pressure for the sample and determining that the effect pressure value has not exceeded the goal pressure value, continuing to determine whether a time in which adjusting the gas pressure is operated has exceeded a predetermined time limit, if the result is positive, determining that the waterproof test fails.

11. The waterproof testing method according to claim 9, further comprising:
after controlling the gas tester to adjust the gas pressure for the sample and determining that the effect pressure value has not exceeded the goal pressure value, continuing to determine whether the time in which adjusting the gas pressure is operated exceeds a predetermined time limit; and
if it is determined that the time has not exceeded the predetermined time limit, continuing to control the gas tester to adjust the gas pressure for the sample.

12. The waterproof testing method according to claim 9, further comprising:
after the gas tester is controlled to adjust the gas pressure for the sample to the goal pressure value to last for the first length of time, determining whether the effect pressure value still maintains within the first pressure range relative to the goal pressure value, if the result is negative, determining that the waterproof test fails.

13. The waterproof testing method according to claim 9, further comprising:
after the gas tester is controlled to stop adjusting the gas pressure for the sample, determining whether the effect pressure value affected on the sample maintains within the second pressure range relative to the goal pressure value, if the result is negative, determining that the waterproof test fails.

14. The waterproof testing method according to claim 9, further comprising:
when it is determined that the time in which the effect pressure value maintains within the second pressure range relative to the goal pressure value has not exceeded the second length of time, continuing to control the gas tester to read the effect pressure value affected on the sample, and determining whether the effect pressure value maintains within the second pressure range relative to the goal pressure value.

15. The waterproof testing method according to claim 9, wherein a method of adjusting the gas pressure is to control the gas tester to add or reduce pressure for the sample.
